(19) United States
(12) Patent Application Publication
(10) Pub. No.: US 2006/0114555 A1
(43) Pub. Date: Jun. 1, 2006

(54) Tilt lens barrel for microscope

(75) Inventor: Masahito Tonooka, Hino-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 11/248,884

(22) Filed: Oct. 12, 2005

(30) Foreign Application Priority Data
Oct. 13, 2004 (JP) 2004-298911
Nov. 30, 2004 (JP) 2004-346682

(51) Int. Cl. G02B 21/00

(52) U.S. Cl. 359/384

(57) ABSTRACT

A lens barrel movable portion to which an eyepiece lens is attached is swiveled with respect to a main body. A first reflecting member which reflects a light beam from a microscope main body swivels in conjunction with swiveling of the lens barrel movable portion. An angle of swiveling is ½ of a swiveling angle of the lens barrel movable portion. A direction of swiveling is the same as a rotating direction of the lens barrel movable portion. As second reflecting member reflects a light beam reflected by the first reflecting member toward the eyepiece lens.

### CROSS-REFERENCE TO RELATED APPLICATIONS

This application is based upon and claims the benefit of priority from prior Japanese Patent Applications No. 2004-298911, filed Oct. 13, 2004; and No. 2004-346682, filed Nov. 30, 2004, the entire contents of both of which are incorporated herein by reference.

### BACKGROUND OF THE INVENTION

1. Field of the Invention

The present invention relates to a tilting observation tube for a microscope which can change a height of an eye point which is a height of eyes of, e.g., a microscopic observer.

2. Description of the Related Art

Each of Jpn. Pat. Appln. KOKAI Publication No. 8-313813 and Jpn. Pat. Appln. KOKAI Publication No. 61-015116 discloses a tilting observation tube for a microscope which can adjust a height of an eye point which is a height of eyes of a microscopic observer. In the tilting observation tube for a microscope, a lens barrel angle of a lens barrel is adjusted in accordance with preferences such as a body type or a posture of a microscopic observer. The lens barrel angle of the lens barrel is an angle of an optical axis of an eyepiece lens with respect to a horizontal plane. With such a tilting observation tube for a microscope, an observation posture of a microscopic observer becomes more comfortable when performing observation using a microscope.

FIG. 15 is a block diagram of a tilting observation tube for a microscope disclosed in Jpn. Pat. Appln. KOKAI Publication No. 8-313813. A tilting observation tube for a microscope 100 includes a lens barrel main body 101 and a rotary frame 102. The lens barrel main body 101 can be attached to a microscope main body 103. The rotary frame 102 is attached to the lens barrel main body 101 in such a manner that it can swivel around a swiveling shaft A. The rotary frame 102 has a binocular lens barrel portion 105 having a pair of eyepiece lenses 104 provided on one end side thereof.

In the tilting observation tube for a microscope 100, an image forming lens 106, a relay lens portion and a reflection optical system 107 are provided. The image forming lens 106, the relay lens portion and the reflection optical system 107 are provided in the lens barrel main body 101 or the rotary frame 102. The image forming lens 106, the relay lens portion and the reflection optical system 107 lead an observation image from the microscope main body 103 to the eyepiece lenses 104.

The relay lens portion is constituted of a concave lens 108 and a convex lens 109. The reflection optical system 107 comprises a prism 110 and first to fifth reflecting mirrors 111 to 115. The fifth reflecting mirror 115 is held by a mirror holding member 116. The mirror holding member 116 is provided to the rotary frame 102. The mirror holding member 116 is provided in such a manner that it can swivel around the swiveling shaft A. The mirror holding member 116 swivels with a swiveling operation of the rotary frame 102 by a gear, a belt, a link or the like. A swiveling angle of the mirror holding member 116 is ½ of a swiveling angle of the rotary frame 102. A swiveling direction of the mirror holding member 116 is the same as a swiveling direction of the rotary frame 102.

A light beam which has entered the image forming lens 106 is reflected by the prism 110 and the first to third reflecting mirrors 111 to 113, transmitted through the concave lens 103, reflected by the fourth and fifth reflecting mirrors 114 and 115, transmitted through the convex lens 109 and enters the pair of eyepiece lenses 104. At this time, the light beam which has entered the image forming lens 106 forms an intermediate image at a point P10 in front of the third reflecting mirror 113. The light beam which has entered the relay lens portion forms an intermediate image at a point P11 in front of the pair of eyepiece lenses 104.

The binocular lens barrel portion 105 swivels at, e.g., a lens barrel angle α by swiveling the rotary frame 102 around the swiveling shaft A. With the swiveling movement of the rotary frame 102, a fifth reflecting mirror 115 swivels in the same direction at α/2. With this swiveling movement, an optical axis from the fifth reflecting mirror 115 toward the binocular lens barrel portion 105 moves from q to q′. As a result, a microscopic observer can change the lens barrel angle α without moving an observation image.

FIG. 16 is a block diagram of a tilting observation tube for a microscope disclosed in Jpn. Pat. Appln. KOKAI Publication No. 61-015116. A lens barrel main body 120 is detachably attached to a microscope main body through an attachment portion 121 of a bottom portion. An imaging adapter 122 is provided at an upper portion of the lens barrel main body 120. For example, a photographic device or a TV device is attached to the imaging adapter 122. A half prism or a half mirror 123 and a prism 124 are provided in the lens barrel main body portion 120. The half prism or the half mirror 123 and the prism 124 respectively lead a light beam which has entered through an objective lens of the microscope main body to a prism 125 and an imaging optical system.

A lens barrel movable portion 126 having a binocular portion is provided to the lens barrel main body 120. The lens barrel movable portion 126 can swivel in a direction of an arrow B with respect to the lens barrel main body 120. Respective eyepiece lenses 127a and 127b are attached to the lens barrel movable portion 126. A plurality of prisms 128 to 134 are provided in the lens barrel movable portion 126 as shown in FIG. 17. The prisms 132 to 134 split a light beam from the prism 131 for respective right and left optical paths, and lead the splited light beams to the respective eyepiece lenses 127a and 127b.

The light beam which has entered through the objective lens is reflected by the respective prisms 125 to 131, reflected by the respective prisms 132 to 134, splited into light beams for the respective right and left optical paths, and enters the respective eyepiece lenses 127a and 127b.

A spring hook 132 is provided on a lower surface of an upper cover of the lens barrel main body 120. A spring hook 133 is provided at an upper portion of the lens barrel movable portion 126. A tension coil spring 134 is stretched between the respective spring hooks 132 and 133. The tension coil spring 134 gives a tension to the lens barrel movable portion 126 in a direction along which the respective eyepiece lenses 127a and 127b move in the direction of the arrow B.

With such a tilting observation tube, a microscopic observer can adjust a height of an eye point by swiveling the lens barrel movable portion 126 with respect to the lens barrel main body 120. When adjusting the height of the eye point, the tension coil spring 134 gives an tension to the lens barrel movable portion 126 in the direction along which the respective eyepiece lenses 127a and 127b move in the direction of the arrow B. As a result, the lens barrel movable portion 126 is pulled by the tension coil spring 134 in a direction opposite to a direction of a force which downwardly swivels by a dead weight. This reduces a difference between an operation force quantity when swiveling the lens barrel movable portion 126 in a rising direction and that when swiveling the same in a downwardly returning direction.

### BRIEF SUMMARY OF THE INVENTION

A tilting observation tube for a microscope, comprising:

a main body which is attached to a microscope main body;

a swiveling shaft which is provided to the main body;

a observation tube movable portion to which an eyepiece is attached and which is supported with respect to the main body in such a manner as to swivel on the swiveling shaft;

a first reflecting member which is provided in such a manner as to swivel on the swiveling shaft, and reflects a light beam from the microscope main body, the first reflecting member swiveling in conjunction with swiveling of the observation tube movable portion, an angle of the swiveling being ½ of a swiveling angle of the observation tube movable portion, a direction of the swiveling being the same as a rotating direction of the observation tube movable portion; and

a second reflecting member which reflects the light beam reflected by the first reflecting member toward the eyepiece.

A tilting observation tube for a microscope, comprising:

a main body which is attached to a microscope main body;

a observation tube movable portion to which an eyepiece is attached and which is supported with respect to the main body in such a manner as to swivel; and

a straining member which strains the main body and the observation tube movable portion,

wherein a straining direction of the straining member substantially matches with a tangent line direction on a swiveling trajectory of the observation tube movable portion at an attachment position of the straining member at a swiveling angle with which a lens barrel angle of the observation tube movable portion with respect to the main body becomes maximum.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external view of a microscope comprising a first embodiment of a tilting observation tube for a microscope according to the present invention;

FIG. 2 is a block diagram of the tilting observation tube for a microscope;

FIG. 3 is an explanatory view of displacement of an observation image at an eye point in the tilting observation tube for a microscope;

FIG. 4 is a block diagram showing a second embodiment of a tilting observation tube for a microscope according to the present invention;

FIG. 5 is a block diagram showing a third embodiment of a tilting observation tube for a microscope according to the present invention;

FIG. 6 is a block diagram showing a fourth embodiment of a tilting observation tube for a microscope according to the present invention;

FIG. 7 is a block diagram showing a state of a minimum tilt angle in a fifth embodiment of a tilting observation tube for a microscope according to the present invention;

FIG. 8 is a block diagram showing a state of a maximum tilt angle of the tilting observation tube for a microscope;

FIG. 9 is a block diagram showing a state of a minimum tilt angle in a sixth embodiment of a tilting observation tube for a microscope according to the present invention;

FIG. 10 is a block diagram showing a state of a maximum tilt angle of the tilting observation tube for a microscope;

FIG. 11 is a side elevation block diagram of a seventh embodiment of a tilting observation tube for a microscope according to the present invention;

FIG. 12 is a partially planimetric block diagram of the tilting observation tube for a microscope;

FIG. 13 is a block diagram showing a minimum tilt angle in an eighth embodiment of a tilting observation tube for a microscope according to the present invention;

FIG. 14 is a block diagram showing a maximum tilt angle of the tilting observation tube for a microscope;

FIG. 15 is a block diagram of a conventional tilting observation tube for a microscope;

FIG. 16 is a block diagram of another conventional tilting observation tube for a microscope; and

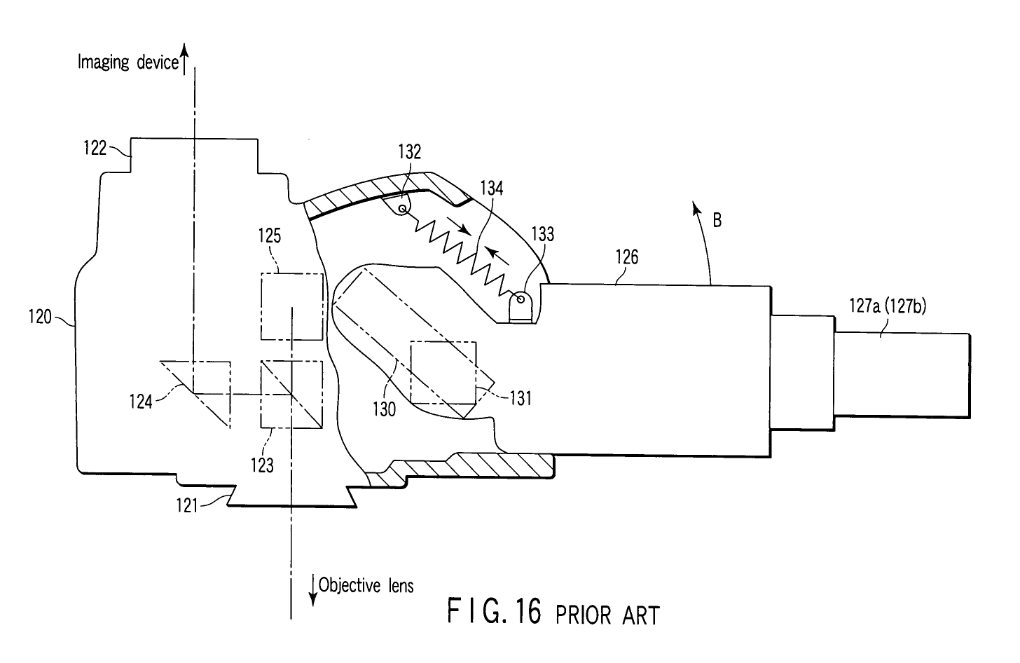

FIG. 17 is a view showing an arrangement of each prism in a lens barrel movable portion in the tilting observation tube for a microscope.

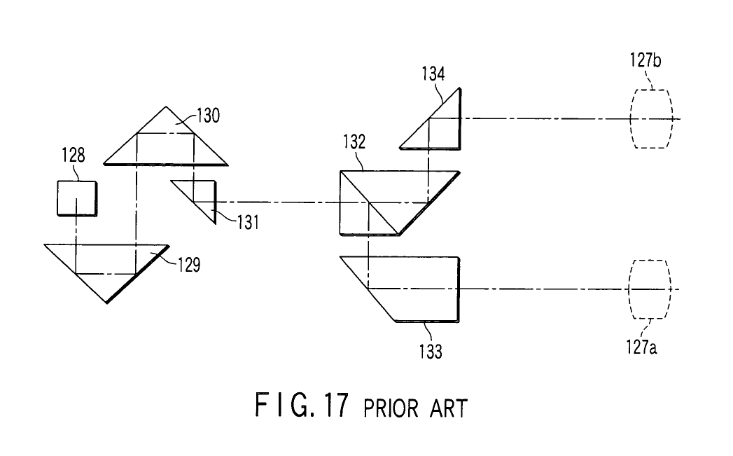

### DETAILED DESCRIPTION OF THE INVENTION

A first embodiment according to the present invention will now be described hereinafter with reference to the accompanying drawings.

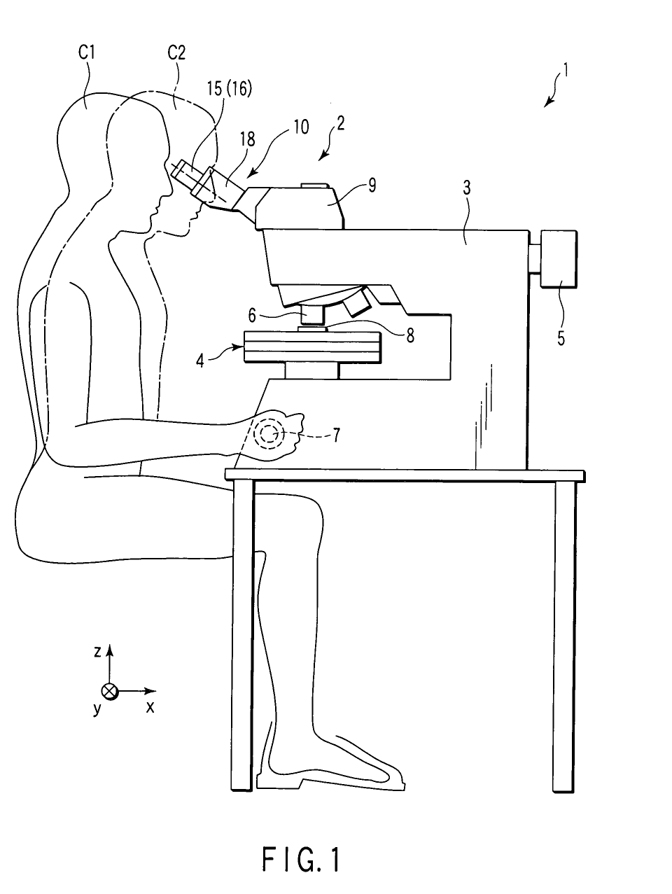

FIG. 1 is an external view of a microscope operated by a microscopic observer. A microscope 1 includes a tilting observation tube for a microscope 2. It is to be noted that a side of the microscope 1 facing a microscopic observer C1 (C2) is determined as a front side. That is, in the microscope 1, an x direction is a depth direction, a y direction is a lateral direction and a z direction is a height direction.

The microscope 1 is, e.g., an upright microscope. The microscope 1 has a microscope main body 3, a stage 4, a lamp socket 5 as a light source, an objective lens 6, and a focusing handle 7. The tilting observation tube for a microscope 2 can be attached to/detached from the microscope main body 3. A sample 8 is mounted on the stage 4. The lamp socket 5 outputs illumination light which illuminates the sample 8. The objective lens 6 condenses an observation image of the sample 8. The focusing handle 7 adjusts focusing by the objective lens 6 with respect to the sample 8.

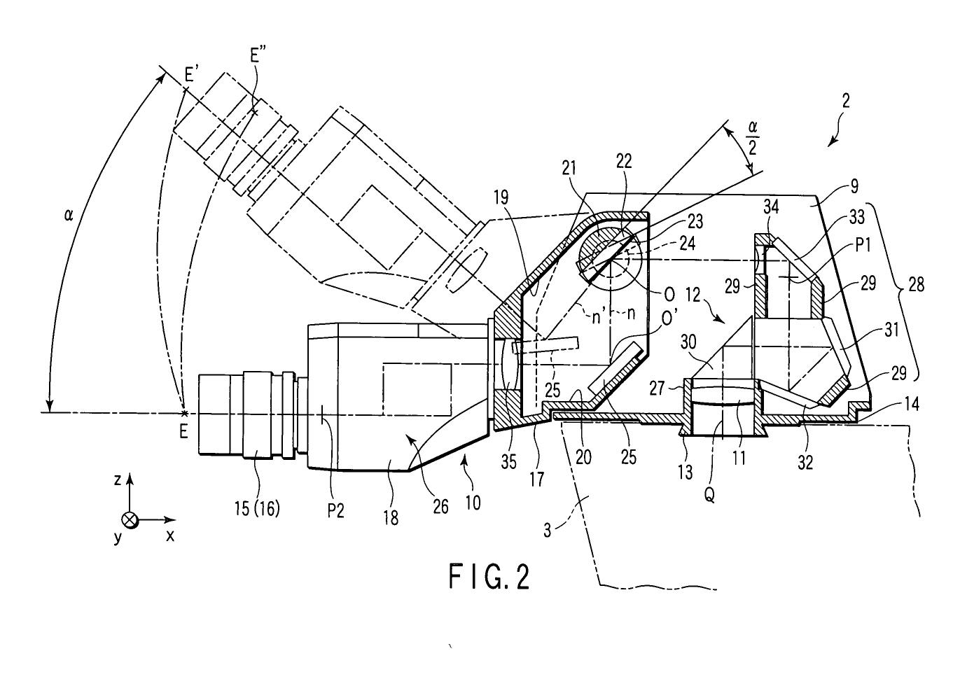

FIG. 2 is a block diagram of the tilting observation tube for a microscope 2. The tilting observation tube for a microscope 2 has a main body 9, a observation tube movable portion 10, an image forming lens 11, a relay lens and a reflection optical system 12. In the main body 9, an attachment portion 13 which can be attached to/detached from the microscope main body 3 is provided. The attachment portion 13 is provided on a bottom portion 14 of the main body 9. The observation tube movable portion 10 is attached to the main body 9 in such a manner that it can swivel around a swiveling axis O. The image forming lens 11 is provided in the main body 9 and leads an observation image from the microscope main body 3 into the main body 9. The relay lens and the reflection optical system 12 lead the observation image from the image forming lens 11 to a pair of eyepiece lenses 15 (16).

The observation tube movable portion 10 has a observation tube main body 17 and a binocular tube 18. The observation tube main body 17 and the binocular tube 18 are integrally provided. The observation tube main body 17 is formed into a tube shape and has an upper surface 19 and a lower surface 20. For example, when the binocular tube 18 is arranged in parallel with the x direction, an inclined surface which is inclined toward an upper right side at an angle of, e.g., substantially 45° with respect to the x direction is provided on the lower surface 20 of the observation tube main body 17. The observation tube main body 17 is provided to the main body 9 in such a manner that it can swivel around the swiveling axis O. The swiveling axis O is provided on the upper surface 19 side in the observation tube main body 17. The swiveling axis O is provided on an upper surface side in the lens barrel movable portion apart from a second reflecting mirror 25. A swiveling shaft 25 is arranged at a height which is substantially the same (a height which is substantially the same in the z direction) as an intermediate point of an arc-like trajectory along which the pair of eyepoint E swivel. Swiveling of the observation tube main body 17 is restricted by, e.g., a stopper. As a result, the observation tube main body 17 swivels in a range of, e.g., a tilt angle α. That is, the observation tube movable portion 10 can move in a range of, e.g., the tilt angle α.

The pair of eyepiece lenses 15 (16) can be attached to/detached from one end side of the binocular tube 18.

A mirror holding member 21 is provided in the observation tube main body 17. The mirror holding member 21 holds a first reflecting mirror 22 as a first reflecting member. The first reflecting mirror 22 has a planar reflecting surface 23. The mirror holding member 21 holds the reflecting surface 23 of the first reflecting mirror 22 in a state where the reflecting surface 23 matches with the swiveling axis O.

A swiveling mechanism 24 is provided to the mirror holding member 21. The swiveling mechanism 24 swivels the mirror holding member 21 in conjunction with swiveling of the observation tube movable portion 10, i.e., the observation tube main body 17. The swiveling mechanism 24 swivels the mirror holding member 21 at an angle α/2 corresponding to ½ of the tilt angle α of the observation tube main body 17. The swiveling mechanism 24 swivels the mirror holding member 21 in the same direction as a swiveling direction of the observation tube main body 17. The swiveling mechanism 24 is formed of, e.g., a gear, a belt, a link or the like. As a result, the first reflecting mirror 22 swivels in conjunction with swiveling of the observation tube movable portion 10. A swiveling angle of the first reflecting mirror 22 is the angle α/2 which is ½ of the tilt angle α of the observation tube movable portion 10. A swiveling direction of the first reflecting mirror 22 is the same as a swiveling direction of the observation tube movable portion 10.

For example, when the binocular tube 18 is arranged in parallel with the x direction like the above description, the lower surface 20 of the observation tube main body 17 is inclined in an upper right direction at an angle of, e.g., substantially 45° with respect to the x direction. That is, the lower surface 20 of the observation tube main body 17 has an inclined surface. A second reflecting mirror 25 as a second reflecting member is fixed on the inclined surface of the lower surface 20. The second reflecting mirror 25 reflects a light beam from the first reflecting mirror 22 toward the binocular tube 18.

An optical axis extending from the first reflecting mirror 22 toward the second reflecting mirror 25 moves in a range of n′ from an optical axis position n within the tilt angle α at which the observation tube movable portion 10 can swivel. A light beam reflected by the first reflecting mirror 22 travels toward the second reflecting mirror 25 arranged below the first reflecting mirror 22 in the z direction.

A light path split optical system 26 is provided in the binocular tube 18. The light path split optical system 26 leads a light beam from the second reflecting mirror 25 to the pair of eyepiece lenses 15 (16).

A lens attachment barrel portion 27 is provided on the bottom portion 14 of the main body 9. The lens attachment barrel portion 27 is provided on an optical axis Q of an observation image (a light beam) from the microscope main body 3. The image forming lens 11 is provided coaxially with the optical axis Q of the observation image in the lens attachment barrel portion 27.

A reflection optical system 28 is provided at an upper portion of the lens attachment barrel portion 27. The reflection optical system 28 is provided on an optical path between the image forming lens 11 and the first reflecting mirror 22, and leads a light beam from the microscope main body 3 to the first reflecting mirror 22. The reflection optical system 28 has a fixing member 29, a prism 30, and a plurality of reflecting mirrors (third to fifth reflecting mirrors) 31 to 33. The prism 30 and the third to fifth reflecting mirrors 31 to 33 are fixed to the fixing member 29.

The prism 30 reflects a light beam from the image forming lens 11 in, e.g., the x direction. The third reflecting mirror 31 is provided on a reflection optical path of the prism 30. The third reflecting mirror 31 reflects a light beam from the prism 30 toward a obliquely downward direction. The fourth reflecting mirror 32 is provided on a reflection optical path of the third reflecting mirror 31. The fourth reflecting mirror 32 reflects a light beam from the third reflecting mirror 31 in, e.g., the z direction. The fifth reflecting mirror 33 is provided on a reflection optical path of the fourth reflecting mirror 32. The fifth reflecting mirror 33 reflects a light beam from the fourth reflecting mirror 32 in, e.g., the x direction. A height position of an axis of light reflected by the fifth reflecting mirror 33 matches with a height position of the swiveling axis O.

A concave lens 34 is provided on the axis of the light reflected by the fifth reflecting mirror 33. The concave lens 34 is fixed to the fixing member 29. A convex lens 35 is provided to the observation tube main body 17. The convex lens 35 is provided on an axis of light reflected by the second reflecting mirror 25. The concave lens 34 and the convex lens 35 form the relay lens.

It is to be noted that an optical axis running through the image forming lens 11, the prism 30, the third to fifth reflecting mirrors 31 to 33, the concave lens 34 and the convex lens 35 is provided on the same plane (a page space of FIG. 2) including an optical axis of the objective lens 6.

The image forming lens 11, the prism 30 and the third and fourth reflecting mirrors 31 and 32 image-form a light beam from the microscope main body 3 at a point P1, thereby forming an intermediate image. The point P1 is provided between the fourth reflecting mirror 32 and the fifth reflecting mirror 33.

The concave lens 34 and the convex lens 35 as the relay lens image-form at a point P2 in the binocular tube 18 a light beam of the intermediate image formed at the point P1, thereby providing an intermediate image. The point P2 is equal to an image surface position of the pair of eyepiece lenses 15 (16).

An operation of the tilting observation tube for a microscope 2 having the above-mentioned configuration will now be described.

First, the sample 8 is mounted on the stage 4. A power supply of the lamp socket 5 is turned on. As a result, the sample 8 is irradiated with illumination light. When the microscopic observer C1 (C2) operates the focusing handle 7, focusing of the objective lens 6 with respect to the sample 8 is adjusted. The microscopic observer C1 (C2) operates the stage 4. As a result, an observation position obtained by the pair of eyepiece lenses 15 (16) is adjusted. That is, a desired observation image of the sample 8 can be obtained through the pair of eyepiece lenses 15 (16).

A light beam from the microscope main body 3 is transmitted through the image forming lens 11 and reflected by the prism 30 and the third to fifth reflecting mirrors 31 to 33. At this time, the image forming lens 11, the prism 30 and the third and fourth reflecting mirrors 31 and 32 image-form the light beam from the microscope main body 3 at the point P1, thereby forming an intermediate image.

A light beam reflected by the fifth reflecting mirror 33 is transmitted through the concave lens 34, reflected by the first and second reflecting mirrors 22 and 25, then transmitted through the convex lens 35, and enters the binocular tube 18. The light beam which has entered the binocular tube 18 is transmitted through the light path split optical system 26 and enters the pair of eyepiece lenses 15 (16). At this time, the concave lens 34 and the convex lens 35 image-form at the point P2 in the binocular tube 18 a light beam of the intermediate image formed at the point P1, thereby forming an intermediate image.

The microscopic observer C1 (C2) swivels the observation tube movable portion 10 within a range of the tilt angle α. The swiveling mechanism 24 swivels the mirror holding member 21 in conjunction with swiveling of the observation tube movable portion 10. In this case, the swiveling mechanism 24 swivels the mirror holding member 21 at the angle α/2 which is ½ of the tilt angle α of the observation tube main body 17 in the observation tube movable portion 10. The swiveling mechanism 24 swivels the mirror holding member 21 in the same direction as the swiveling direction of the observation tube main body 17.

As a result, the first reflecting mirror 22 swivels in conjunction with swiveling of the observation tube movable portion 10. A swiveling angle of the first reflecting mirror 22 is α/2. A swiveling direction of the first reflecting mirror 22 is the same as a swiveling direction of the observation tube movable portion 10.

When the first reflecting mirror 22 swivels with swiveling of the observation tube movable portion 10 in this manner and the second reflecting mirror 25 thereby moves, an optical axis extending from the first reflecting mirror 22 toward the second reflecting mirror 25 moves within a range of n′ from an optical axis position n. The optical axis range of n′ from the optical axis position n is within the tilt angle α at which the observation tube movable portion 10 can swivel.

A relative position relationship between the second reflecting mirror 25 and the light path split optical system 26 in the binocular tube 18 is always the same irrespective of swiveling of the observation tube movable portion 10. Therefore, likewise, a light beam reflected by the fifth reflecting mirror 33 is transmitted through the concave lens 34, reflected by the first and second reflecting mirrors 22 and 25, then transmitted through the convex lens 35, and enters the binocular tube 18. The light beam which has entered the binocular tube 18 is transmitted through the light path split optical system 26 and enters the pair of eyepiece lenses 15 (16). As a result, the microscopic observer can observe an observation image without moving the observation image even if the observation tube movable portion 10 is swiveled within the tilt angle α.

When the tilt angle α of the observation tube movable portion 10 is changed, an eye point moves on a trajectory E-E′. When the tilt angle α of the observation tube movable portion 10 is set to a maximum value, the eye point is positioned on a point E′ of the trajectory. At this time, the microscopic observer takes a posture of the microscopic observer C1 shown in FIG. 1.

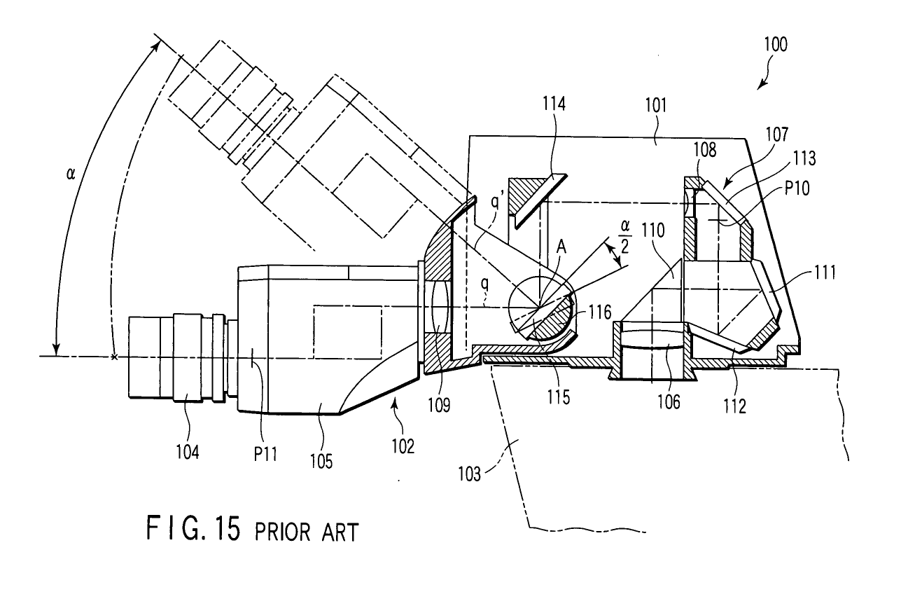

On the contrary, when the first reflecting mirror 22 is fixed and the second reflecting mirror 25 is swiveled like a prior art shown in FIG. 15, the eye point moves on a trajectory E-E″. At this time, the microscopic observer takes a posture of the microscopic observer C2 shown in FIG. 1.

Comparing the trajectory E-E′ of the eye point with the trajectory E-E″ of the eye point, when the tilt angle α of the observation tube movable portion 10 is set to the maximum angle, the eye point E′ is closer to the front side than the eye point E″. Therefore, the microscopic observer C1 can perform observation without inclining his/her posture in the depth direction.

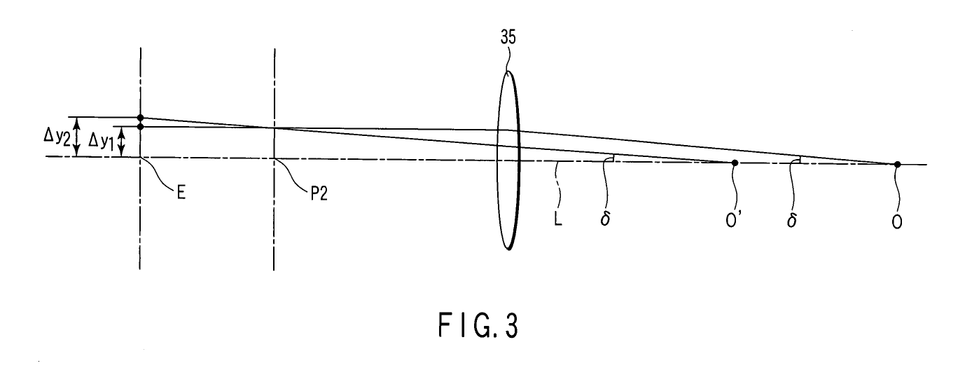

Next, when the observation tube movable portion 10 is swiveled around the swiveling axis O, it can be considered that the first reflecting mirror 22 does not swivel at an angle which is ½ of the tilt angle α. Displacement of an observation image at an eye point in this case will now be described with reference to FIG. 3.

The displacement of the observation image at the eye point occurs due to a dimension error or the like in each component generated in manufacture. Even if the observation tube movable portion 10 swivels at the tilt angle α due to a dimension error or the like, the first reflecting mirror 22 does not swivel in the same direction at an angle which is ½ of the tilt angle α. As a result, the displacement of the observation image at the eye point occurs.

It is to be noted that, in FIG. 3, an optical axis L is shown as a linear optical axis which has reached the point P after reflected by the first reflecting mirror 22 when the first reflecting mirror 22 swivels at an angle which is ½ of the tilt angle α, i.e., when an error is not generated.

When the first reflecting mirror 22 does not swivel at an angle which is ½ of the tilt angle α, a light beam reflected by the first reflecting mirror 22 is reflected by the second reflecting mirror 25, transmitted through the convex lens 35 and forms an intermediate image at the point P2. A displacement quantity of the observation image generated at the point P2 is Δy1. In FIG. 3, the light beam reflected by the first reflecting mirror 22 is determined as being reflected at an angle δ from a reflection point matching with the swiveling axis O.

On the contrary, in a case where a reflection point O′ of the second reflecting mirror 25 is determined as a swiveling shaft, the displacement quantity of the observation image at the point P2 is Δy2 when an error is generated in a swiveling angle of the second reflecting mirror 25. It is to be noted that the light beam reflected by the second reflecting mirror 25 in FIG. 3 is determined as being reflected at the angle δ from the reflection point O′.

Comparing the displacement quantities Δy1 and Δy2 of the observation image produced at the point P2, the displacement quantity Δy1 is smaller than the displacement quantity Δy2. In a case where the same angular error δ is generated, the displacement quantity of the observation image is smaller when a position at which the error is generated is distanced from the point P2.

Therefore, the displacement quantity of the observation image at the eye point E becomes smaller by swiveling the first reflecting mirror 22 rather than swiveling the second reflecting mirror 25.

As described above, according to the first embodiment, the first reflecting mirror 22 is swiveled around the swiveling axis O, and the observation tube movable portion 10 is swiveled within the range of the tilt angle α. As a result, when the tilt angle α of the observation tube movable portion 10 is increased, a distance of moving the eye point E′ in the depth direction can be shortened. The microscopic observer C1 can perform observation without inclining his/her posture in the depth direction.

Therefore, both the small microscopic observer C1 and the large microscopic observer C1 can excellently maintain his/her posture during observation. The microscopic observer C1 can reduce fatigue during observation. The microscopic observer C1 can perform excellent observation even in a long period of time.

Since the reflection point of the first reflecting mirror 22 is matched with the swiveling axis O, a distance between the swiveling axis O (a reflection point of a light beam) on the first reflecting mirror 22 and the eye point E is longer than a distance between the reflection point O′ on the second reflecting mirror 25 and the eye point E as compared with the case where the reflection point O′ on the second reflecting mirror 25 is determined as the swiveling shaft.

Even if the observation tube movable portion 10 swivels at the tilt angle α due to a dimension error or the like in each component generated during manufacture, the swiveling angle of the first reflecting mirror 22 may not be ½ of α but include a slight error. Even in such a case, a displacement quantity of an observation image at the eye point E can be reduced.

Therefore, when the observation tube movable portion 10 is swiveled at the tilt angle Δ, deterioration in an observation image due to the optical system can be suppressed.

A second embodiment according to the present invention will now be described. It is to be noted that like reference numerals denote parts equal to those in the first embodiment, thereby eliminating their detailed explanation.

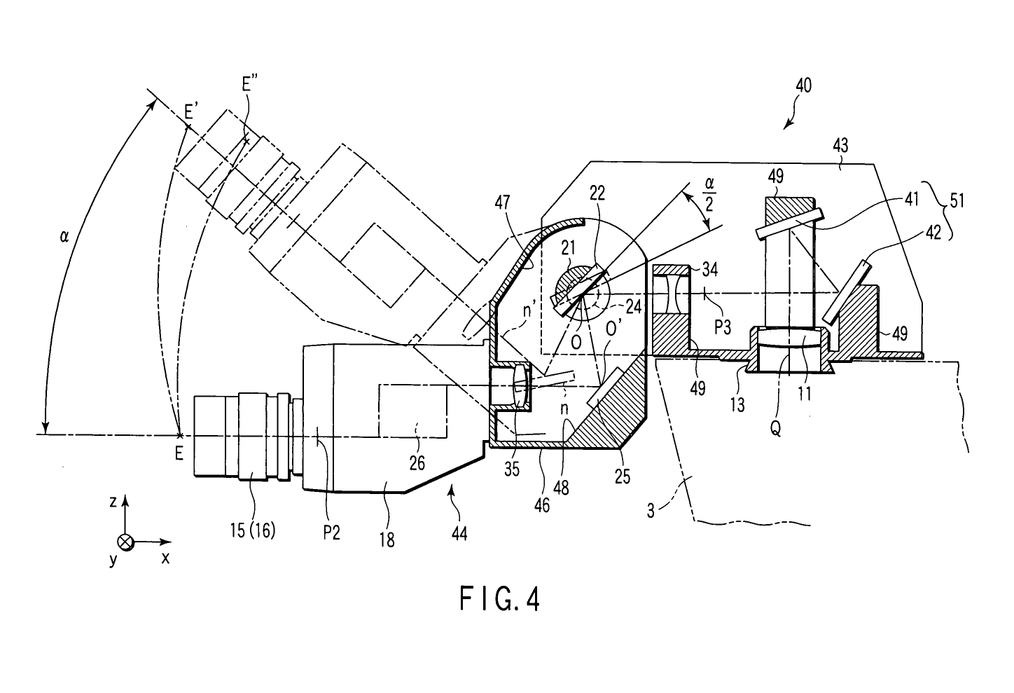

FIG. 4 is a block diagram showing a tilting observation tube for a microscope 40. A difference of the tilting observation tube for a microscope 40 from the first embodiment lies in that a sixth reflecting mirror 41 and a seventh reflecting mirror 42 are provided between an image forming lens 11 and a concave lens 34.

The tilting observation tube for a microscope 40 has a lens barrel main body 43, a lens barrel movable portion 44, the image forming lens 11 and a relay lens (a concave lens 34 and a convex lens 35) and a reflection optical system 51. In the lens barrel main body 43, an attachment portion 13 which is attached to a microscope main body 3 is provided.

The lens barrel movable portion 44 has a observation tube main body 46 and a binocular tube 18. The observation tube main body 46 and the binocular tube 18 are integrally provided. The observation tube main body 46 is formed into a tube shape (e.g., a case or a housing) and has an upper surface 47 and a lower surface 48. For example, when the binocular tube 18 is arranged in parallel with an x direction, the observation tube main body 46 is provided to be inclined toward an upper right side with respect to the x direction. The observation tube main body 46 is provided to the lens barrel main body 43 in such a manner that it can swivel around a swiveling axis O. The swiveling axis O is provided on the upper surface 47 side apart from a second reflecting mirror 25 in the observation tube main body 46.

A mirror holding member 21 is provided in the observation tube main body 46. The mirror holding member 21 holds a first reflecting mirror 22. Like the above example, the first reflecting mirror 22 swivels in conjunction with swiveling of the lens barrel movable portion 44. A swiveling angle of the first reflecting mirror 22 is an angle α/2 which is ½ of a tilt angle α of the lens barrel movable portion 44. A swiveling direction of the first reflecting mirror 22 is the same as a swiveling direction of the lens barrel movable portion 44.

For example, when the binocular tube 18 is arranged in parallel with the x direction, the lower surface 48 of the observation tube main body 46 is inclined toward an upper right side with respect to the x direction. The second reflecting mirror 25 is fixed on the lower surface 48 of the observation tube main body 46.

An optical axis extending from the first reflecting mirror 22 toward the second reflecting mirror 25 moves in a range of n′ from an optical axis position n in the tilt angle α at which the lens barrel movable portion 44 can swivel. A light beam reflected by the first reflecting mirror 22 travels toward the second reflecting mirror 25 arranged below the first reflecting mirror 22 in a z direction.

The reflection optical system 51 is provided on an optical path between the image forming lens 11 and the first reflecting mirror 22, and leads a light beam from the microscope main body 3 to the first reflecting mirror 22. The reflection optical system 45 has a fixing member 49, a sixth reflecting mirror 41 and a seventh reflecting mirror 42. The sixth and seventh reflecting mirrors 41 and 42 are fixed to the fixing member 49.

The sixth reflecting mirror 41 is provided on an optical axis of the image forming lens 11. The sixth reflecting mirror 41 reflects a light beam from the image forming lens 11. The seventh reflecting mirror 42 is provided on a reflection optical path of the sixth reflecting mirror 41. The seventh reflecting mirror 42 reflects a light beam from the sixth reflecting mirror 41 toward the concave lens 34. A height position of an axis of light reflected by the seventh reflecting mirror 42 matches with a height position of the swiveling axis O.

The image forming lens 11 and the sixth and seventh reflecting mirrors 41 and 42 image-form an image of a light beam from the microscope main body 3 at a point P3, thereby forming an intermediate image. The point P3 exists between the concave lens 34 and the seventh reflecting mirror 42.

An operation of the tilting observation tube for a microscope 40 having the above-mentioned configuration will now be described.

A light beam from the microscope main body 3 is transmitted through the image forming lens 11, reflected by the sixth and seventh reflecting mirrors 41 and 42, and enters the concave lens 34. At this time, the image forming lens 11 and the sixth and seventh reflecting mirrors 41 and 42 image-form the light beam from the microscope main body 3 at the point P3, thereby forming an intermediate image.

A light beam transmitted through the concave lens 34 is reflected by the first reflecting mirror 22 and the second reflecting mirror 25, transmitted through the convex lens 35, and enters the binocular tube 18. The light beam which has entered the binocular tube 18 is transmitted through a light path split optical system 26, and enters a pair of eyepoint E. At this time, the concave lens 34 and the convex lens 35 image-form at a point P2 in the binocular tube 18 the light beam of the intermediate image formed at the point P3, thereby forming an intermediate image.

A microscope observer C1 (C2) swivels the lens barrel movable portion 44 within a range of the tilt angle α. A swiveling mechanism 24 swivels the mirror holding member 21 in conjunction with swiveling of the lens barrel movable portion 44. As a result, the first reflecting mirror 22 swivels in conjunction with swiveling of the lens barrel movable portion 44. A swiveling angle of the first reflecting mirror 22 is an angle α/2 which is ½ of the tilt angle α of the lens barrel movable portion 44. A swiveling direction of the first reflecting mirror 22 is the same as a swiveling direction of the lens barrel movable portion 44.

When the first reflecting mirror 22 swivels with swiveling of the lens barrel movable portion 44 in this manner and the second reflecting mirror 25 thereby moves, an optical axis extending from the first reflecting mirror 22 toward the second reflecting mirror 25 moves within a range of n′ from an optical axis position n.

A relative position relationship between the second reflecting mirror 25 and the light path split optical system 26 is always the same irrespective of swiveling of the lens barrel movable portion 44. Therefore, like the above-described example, a light beam reflected by the seventh reflecting mirror 42 is transmitted through the concave lens 34, reflected by the first and second reflecting mirrors 22 and 25, then transmitted through the convex lens 35, and enters the binocular tube 18. The light beam which has entered the binocular tube 18 is transmitted through the light path split optical system 26 and enters the pair of eyepoint E. As a result, the microscopic observer can observe an observation image without moving the observation image even if the lens barrel movable portion 44 is swiveled within the tilt angle α.

When the tilt angle α of the observation tube movable portion 10 is changed, an eye point moves on a trajectory E-E′. When the tilt angle α of the lens barrel movable portion 44 is increased, an eye point E′ is closer to the front side than an eye point E″ like the above example. Therefore, the microscopic observer C1 can perform observation without inclining his/her posture in a depth direction.

As described above, according to the second embodiment, the first reflecting mirror 22 is swiveled around the swiveling axis O, and the observation tube movable portion 10 is swiveled within the range of the tilt angle α. As a result, the same effects as those of the first embodiment can be demonstrated.

Since the reflection optical system 51 is constituted of two reflecting mirrors, i.e., the sixth reflecting mirror 41 and the seventh reflecting mirror 42, the number of times of reflection of a light beam can be reduced to two. That is, the number of times of reflection, i.e., two is smaller than the number of times of reflection, i.e., four in the reflection optical system 28 of the first embodiment. If the number of times of reflection is small, the number of times that the light beam is transmitted through an optical member such as a reflecting mirror is small, a light quantity of a light beam is small, and coloring is less performed. Therefore, the microscopic observer C1 can observe a bright observation image which is less colored.

A third embodiment according to the present invention will now be described. It is to be noted that like reference numerals denote parts equal to those in each of the foregoing embodiments, thereby eliminating their detailed description.

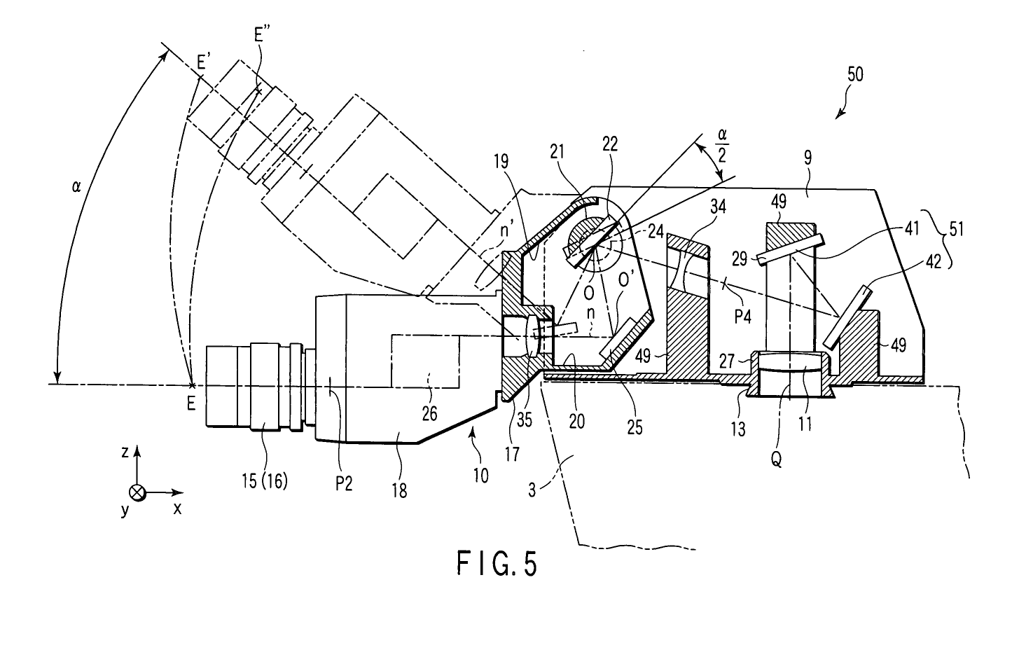

FIG. 5 is a block diagram showing a tilting observation tube for a microscope 50. A difference of the tilting observation tube for a microscope 50 from the second embodiment lies in that an axis of light reflected by a seventh reflecting mirror 42 is directed upward apart from an x direction.

The tilting observation tube for a microscope 50 has a reflection optical system 51. The reflection optical system 51 has a sixth reflecting mirror 41 and the seventh reflecting mirror 42. The sixth reflecting mirror 41 is provided on an optical axis extending from an image forming lens 11. The sixth reflecting mirror 41 reflects a light beam from the image forming lens 11. The seventh reflecting mirror 42 is provided on a reflection optical path of the sixth reflecting mirror 41. The seventh reflecting mirror 42 reflects a light beam from the sixth reflecting mirror 41 toward a convex lens 34. A direction of an axis of light reflected by the seventh reflecting mirror 42 is above the x direction. The axis of the light reflected by the seventh reflecting mirror 42 matches with a swiveling axis O.

The image forming lens 11 and the sixth and seventh reflecting mirrors 41 and 42 image-form a light beam from a microscope main body 3 at a point P, thereby forming an intermediate image. The point P4 exists between the seventh reflecting mirror 42 and the concave lens 34.

An operation of the thus configured tilting observation tube for a microscope 50 will now be described.

A light beam from the microscope main body 3 is transmitted through the image forming lens 11, and reflected by each of the sixth and seventh reflecting mirrors 41 and 42. At this time, the seventh reflecting mirror 42 reflects the light beam in a direction above the x direction. The light beam reflected by the seventh reflecting mirror 42 is transmitted through the concave lens 34, reflected by each of a first reflecting mirror 22 and a second reflecting mirror 25, transmitted through a convex lens 35 and enters a binocular tube 18. At this time, the image forming lens 11 and the sixth and seventh reflecting mirrors 41 and 42 image-form the light beam from the microscope main body 3, thereby forming an intermediate image.

The light beam which has entered the binocular tube 18 is transmitted through a light path split optical system 26 and enters a pair of eyepiece lenses 15 (16). At this time, the concave lens 34 and the convex lens 35 image-form at a point P2 in the binocular tube 18 the light beam of the intermediate image formed at the point P4, thus forming an intermediate image.

A microscopic observer C1 (C2) swivels a observation tube movable portion 10 within a range of a tilt angle α. A swiveling mechanism 24 swivels a mirror holding member 21 in conjunction with swiveling of the observation tube movable portion 10. As a result, the first reflecting mirror 22 swivels in conjunction with swiveling of the observation tube movable portion 10. A swiveling angle of the first reflecting mirror 22 is an angle α/2 which is ½ of the tilt angle α of the lens barrel movable portion 44. A swiveling direction of the first reflecting mirror 22 is the same as a swiveling direction of the observation tube movable portion 10.

When the first reflecting mirror 22 swivels with swiveling of the observation tube movable portion 10 in this manner and the second reflecting mirror 25 thereby moves, an optical axis extending from the first reflecting mirror 22 toward the second reflecting mirror 25 moves in a range of n′ from an optical axis position n.

A relative position relationship between the second reflecting mirror 25 and a light path split optical system 26 is always the same irrespective of swiveling of the lens barrel movable portion 44. Therefore, like the above example, the microscope observer can observe an observation image without moving the observation image even if the lens barrel movable portion 44 swivels within the tilt angle α.

When the tilt angle α of the observation tube movable portion 10 is changed, an eye point moves on a trajectory E-E′. When the tilt angle α of the lens barrel movable portion 44 is set to a maximum value, an eye point E′ is closer to the front side than an eye point E′ like the above example. Therefore, the microscopic observer C1 can perform observation without inclining his/her posture in a depth direction.

As described above, according to the third embodiment, the first reflecting mirror 22 is swiveled around the swiveling axis O, and the observation tube movable portion 10 is swiveled within the range of the tilt angle α. As a result, the same effects as those of the first embodiment can be demonstrated.

The seventh reflecting mirror 42 reflects a light beam in a direction above the x direction. As a result, arrangement positions of the first reflecting mirror 22, the binocular tube 18 and the eyepiece lenses 15 (16) can be set high. A space required to arrange the relay lens (the concave lens 34 and the convex lens 35) and the reflection optical system 51 can be reduced.

The microscope main body 3 has each observation optical system for, e.g., bright field observation, dark field observation, polarized light observation or fluorescence observation. The microscope main body 3 contains each optical element required for each observation optical system. The microscope main body 3 has a illuminator. The light projection tube has a shape which protrudes toward the microscopic observer C1 (C2) side. The tilting observation tube for a microscope 50 can be applied even in case of such a microscope main body 3.

A fourth embodiment according to the present invention will now be described. It is to be noted that like reference numerals denote parts equal to those in each of the foregoing embodiments, thereby eliminating their detailed description.

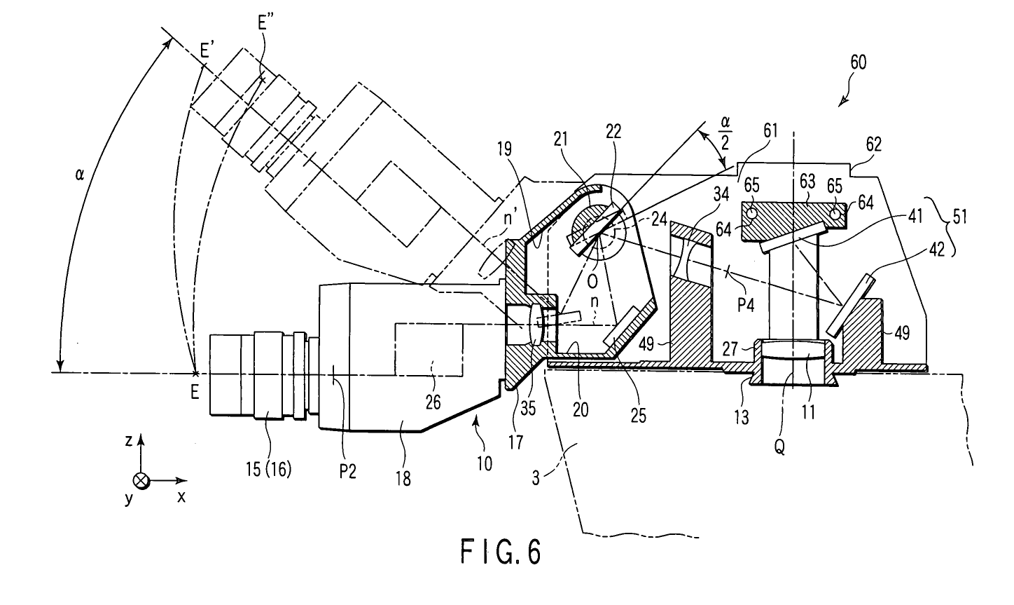

FIG. 6 is a block diagram showing a tilting observation tube for a microscope 60. A difference of the tilting observation tube for a microscope 60 from the second embodiment lies in that a sixth reflecting mirror 41 can be inserted into or removed from an optical axis Q from a microscope main body 3.

An imaging device attachment portion 62 is provided on an upper surface of a lens barrel main body 61. The imaging device attachment portion 62 is provided on the optical axis Q from the microscope main body 3. For example, a photographic device or a television device can be attached to/detached from the imaging deice attachment portion 62.

A fixing member 63 is movably provided in the lens barrel main body 61. Respective guide holes 64 and 64 are provided in the fixing member 63. A pair of guides 65 and 65 are provided in the lens barrel main body 61. Each of the guides 65 and 65 is formed into a rod-like shape. Each of the guides 65 and 65 is provided in a direction vertical to a page space of FIG. 6 and in parallel with each other.

The fixing member 63 can move in the lens barrel main body 61 by fitting the respective guides 65 and 65 in the respective guide holes 64 and 64. A knob is provided to the fixing member 63. The knob protrudes toward the outside of a case main body 61. A microscopic observer C1 (C2) operates the knob. As a result, the fixing member 63 can be inserted into/removed from the optical axis of the microscope main body 3.

A sixth reflecting mirror 41 is provided to the fixing member 63. Therefore, the sixth reflecting mirror 41 can be inserted into/removed from the optical axis Q from the microscope main body 3.

As described above, according to the fourth embodiment, the first reflecting mirror 22 is swiveled around the swiveling axis O, and the observation tube movable portion 10 is swiveled within a range of a tilt angle α. The seventh reflecting mirror 42 reflects a light beam in a direction above the x direction. As a result, the same effects as those of the third embodiment can be demonstrated.

The sixth reflecting mirror 41 can be inserted into/removed from the optical axis Q from the microscope main body 3. When the sixth reflecting mirror 41 is arranged on the optical axis, the eyepiece lenses 15 (16) enable observation by naked eyes. When the sixth reflecting mirror 41 is retracted from the optical axis, it is possible to perform imaging observation using an imaging device such as a photographic device or a television device. Therefore, macroscopic observation and imaging observation can be switched.

In this embodiment, a light path division optical system may be used in place of the sixth reflecting mirror 41. The light path division optical system divides an optical axis transmitted through the image forming lens 11 into two directions, leads one light beam to the sixth reflecting mirror 41, and leads the other light beam to the imaging device attachment portion 62. As a result, macroscopic observation and imaging observation can be arbitrarily selected at the same time.

A fifth embodiment according to the present invention will now be described. It is to be noted that like reference numerals denote parts equal to those in the fourth embodiment, thereby eliminating their detailed explanation.

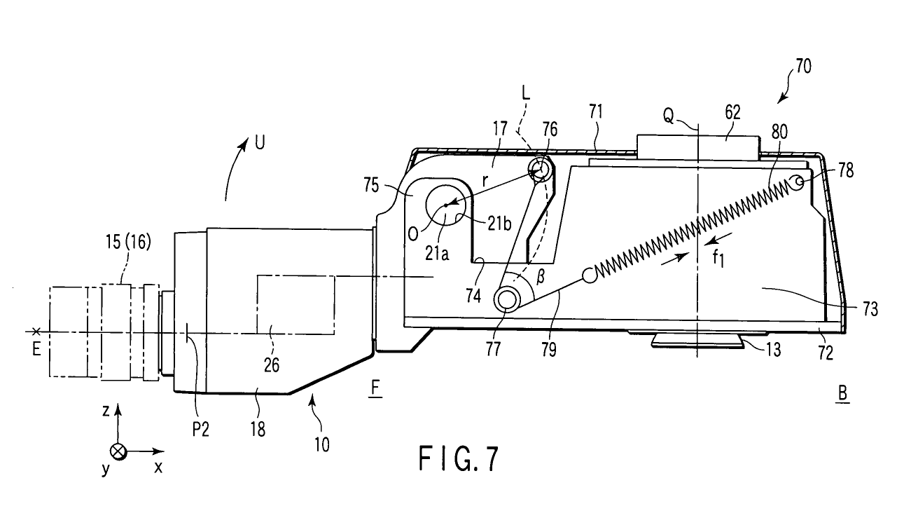

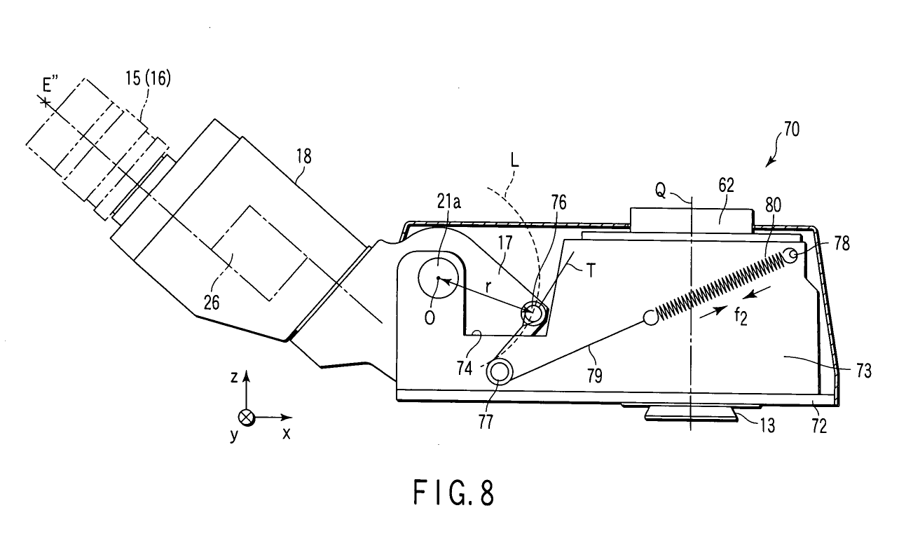

FIGS. 7 and 8 are block diagrams of a tilting observation tube for a microscope 70. FIG. 7 is a block diagram when a minimum tilt angle α is provided. FIG. 8 is a block diagram when a maximum tilt angle α is provided. Like the example shown in FIG. 6, the tilting observation tube for a microscope 70 has a lens barrel main body 71, a observation tube movable portion 10, an image forming lens 11, a relay lens (a concave lens 34 and a convex lens 35) and a reflection optical system 51.

The observation tube movable portion 10 has a observation tube main body 17 and a binocular tube 18. The observation tube main body 17 is provided to the lens barrel main body 71 in such a manner that it can swivel around a swiveling axis O.

In the lens barrel main body 71 is provided an attachment portion 13 which can be attached to/removed from a microscope main body 3.

An imaging device attachment portion 62 is provided on an optical axis Q from the microscope main body 3. For example, a photographic device or a television device can be attached to/removed from the imaging device attachment portion 62.

The lens barrel main body 71 is constituted of a bottom plate 72 and each side plate 73 as shown in FIGS. 7 and 8. The respective side plates 73 are provided upright on both sides of the bottom plate 72. It is to be noted that FIGS. 7 and 8 show one side plate 73. A notch portion 74 is provided to the side plate 73.

The notch portion 74 is provided by notching the side plate 73 from an upper part toward a lower part. Here, a side on which each binocular eyepiece lens 15 (16) is provided is determined as a front surface F, and its opposite side is determined as a back surface B. A swiveling support plate 75 is provided on the front surface F side apart from the notch portion 74. The swiveling axis O is provided to the swiveling support plate 75. The swiveling axis O supports the lens mirror movable portion 10 in such a manner that the lens mirror movable portion 10 can swivel. It is to be noted that a mirror holding member 21 is connected with a movable shaft 21a. The movable shaft 21a is supported in a rotary shaft hole 21b provided to the swiveling support plate 75.

A wire fixing terminal 76 as a first fixing portion is provided on a side surface of the observation tube movable portion 10. Specifically, as shown in FIG. 7, the wire fixing terminal 76 is provided at an upper part of the observation tube main body 17 on the back surface B side. The upper part of the observation tube main body 17 on the back surface B side is a position when the observation tube movable portion 10 is set with the minimum tilt angle α.

The wire fixing terminal 76 is provided above an opening of the notch portion 74. The wire fixing terminal 76 is separated from the swiveling axis O by a predetermined distance r. Therefore, when the observation tube movable portion 10 moves around the swiveling axis O, the wire fixing terminal 76 moves around the swiveling axis O to describe an arc with the predetermined gap r being determined as a radius. FIGS. 7 and 8 show an arc-like trajectory L of the wire fixing terminal 76.

A roller guide 77 as a hook member is provided on the side plate 73. The roller guide 77 is provided on the side plate 73 below the notch portion 74. The roller guide 77 is rotatably provided on the side plate 73.

A spring hook member 78 as a second fixing portion is provided on the side plate 73. The spring hook member 78 is provided at an upper part of the side plate 73 on the back surface B side.

A wire 79 as a streak thing and a tension coil spring 80 as a tensile elastic member (a contraction member) are stretched between the wire fixing terminal 76 and the spring hook member 78. The wire 79 and the tension coil spring 80 are coupled with each other in series.

On end of the wire 79 is fixed at the wire fixing terminal 76. The wire 79 is hooked around the roller guide 77. The other end of the wire 79 is coupled with one end of the tension coil spring 80 by, e.g., fastening. The other end of the tension coil spring 80 is caught by the spring hook member 78. An angle β obtained by bending the wire 79 hooked around the roller guide 77 has an acute angle.

The tension coil spring 80 has a tensile force, i.e., a force of contracting in a contraction direction f₁ shown in FIG. 7. Therefore, the wire 79 and the tension coil spring 80 give an impetus which swivels the observation tube movable portion 10 in a direction of an arrow U by the force in the contraction direction f₁. The tension coil spring 80 generates a torque in a direction opposite to tare weights of each eyepiece lens 15 (16) and the observation tube movable portion 10. As a result, the tension coil spring 80 balances the tare weights of each eyepiece lens 15 (16) and the observation tube movable portion 10 and the torque in a direction opposite to the tare weights. It is to be noted that the tension coil spring 80 having a spring constant which is as small as possible is used.

A straining direction of the wire 79 between one end of the wire 79 and the roller guide 77 substantially matches with a tangent line direction T on an arc-like trajectory L of the wire fixing terminal 76 when the observation tube movable portion 10 swivels at the tilt angle α in a state where the observation tube movable portion 10 is moved up to an uppermost point as shown in FIG. 8.

An operation of the thus configured tilting observation tube for a microscope 70 will now be described.

A microscopic observer C1 (C2) changes the tilt angle α of the observation tube movable portion 10 in order to vary a height position of an eye point. In conjunction with swiveling of the observation tube movable portion 10, the first reflecting mirror 22 swivels at an angle which is ½ of the tilt angle α in the same angle direction. As a result, an observation image does not move, and a height of the eye point can be continuously changed.

A function of the tension coil spring 80 when adjusting the eye point will now be described.

The microscopic observer C1 (C2) swivels the observation tube movable portion 10. As a result, an eye point position varies within a range of the minimum tilt angle α shown in FIG. 7 and the maximum tilt angle α shown in FIG. 8.

In a state where the tilt angle α is set to the minimum angle as shown in FIG. 7, a position of the wire fixing terminal 76 is the highest position on the trajectory L which moves around the swiveling axis O to describe an arc. In this state, a gap between the wire fixing terminal 76 and the spring hook member 78 is expanded to the maximum level through the roller guide 77. Therefore, the tension coil spring 80 has both ends thereof being stretched. As a result, the tension coil spring 80 is in a state where its tensile force is increased to the maximum level.

Consequently, the tension coil spring 80 gives a great impetus to the wire fixing terminal 76 through the wire 79. That is, the tension coil spring 80 gives the wire fixing terminal 76 a large impetus f₁ which moves the observation tube movable portion 10 in a direction of an arrow U.

In a state where the tilt angle α is set to the maximum angle as shown in FIG. 8, a position of the wire fixing terminal 76 is a lowest position on the trajectory L which moves around the swiveling axis O to describe an arc. In this state, the gap between the wire fixing terminal 76 and the spring hook member 78 is reduced to become the minimum gap through the roller guide 77. Therefore, the tension coil spring 80 has both ends thereof being contracted. As a result, the tension coil spring 80 is in a state where its impetus is reduced to the minimum level.

Consequently, the tension coil spring 80 gives the wire fixing terminal 76 a small tensile force through the wire 79. That is, the tension coil spring 80 gives the wire fixing terminal 76 a small impetus f₂ which swivels the observation tube movable portion 10 in the direction of the arrow U. At this time, the impetus f₂ has a relationship of f₂<f₁.

Therefore, when changing the eye point position, the microscopic observer C1 (C2) swivels the observation tube movable portion 10 in the direction of the arrow U or a direction opposite thereto. As this time, a tension coil spring 55 expands/contracts to change the impetus which is given to the lens barrel movable portion 24. That is, the tension coil spring 55 reduces the impetus which is given to the observation tube movable portion 10 as the tilt angle α of the observation tube movable portion 10 is increased. The tension coil spring 55 increases the impetus which is given to the observation tube movable portion 10 as the tilt angle α is changed from the maximum angle to the minimum angle.

In a state where the tilt angle α is set to the maximum angle, the wire 79 is set to be pulled in the tangent line direction T of the trajectory of the wire fixing terminal 76 which moves to describe an arc. The wire 79 is set to be pulled in a direction which gradually deviates from the tangent line direction T of the trajectory L as the tilt angle α is changed from the maximum angle to the minimum angle. As a result, even if the tensile force of the tension coil spring 80 is increased, a variation of the torque which swivels the observation tube movable portion 10 can be suppressed.

As described above, according to the fifth embodiment, the wire 79 and the tension coil spring 80 are stretched between the lens barrel main body 71 and the observation tube movable portion 10, and the wire 79 is hooked around the roller guide 77 provided in the lens barrel main body 71. As a result, the impetus given to the observation tube movable portion 10 can be reduced as the tilt angle α of the observation tube movable portion 10 is changed from the minimum angle to the maximum angle. The impetus given to the observation tube movable portion 10 is increased as the tilt angle α is changed from the maximum angle to the minimum angle.

In case of adjusting a height position of the eye point in accordance with a preference of the microscopic observer C1 (C2), the microscopic observer C1 (C2) can swivel the observation tube movable portion 10 by a quantity of a uniform operation force in a full range of the tilt angle α of the observation tube movable portion 10. A quantity of an operation force by the microscopic observer C1 (C2) is uniform without being dependent on swiveling in a rising direction of the observation tube movable portion 10 and in an opposite direction thereof.

As the tension coil spring 80, one having a spring constant which is as small as possible is used. As a result, a difference in a quantity of the operation force between the minimum tilt angle α and the maximum tilt angle α can be reduced.

In a state where the tilt angle α is set to the maximum angle, the wire 79 is set to be pulled in the tangent line direction T of the trajectory L of the wire fixing terminal 76 which moves to describe an arc. The wire 79 is set to be pulled in a direction which gradually deviates from the tangent line direction T of the trajectory L as the tilt angle α is changed from the maximum angle to the minimum angle. As a result, even if the tensile force of the tension coil spring 80 is increased, a variation in the torque which swivels the observation tube movable portion 10 can be suppressed.

The tension coil spring 80 has a small spring constant. The observation tube movable portion 10 has a large mass. In order to give a torque required to perform a tilt operation with respect to the observation tube movable portion 10 by using such a tension coil spring 80, a long span is required. Provision of the long span can be realized by hooking the wire 79 and the tension coil spring 80 around the roller guide 77 and bending them.

When the fifth embodiment has the following conditions, the tilt operation can be performed with respect to the observation tube movable portion 10 with a uniform quantity of the operation force. Further, the operation force is uniform in a full range of the tilt angle α of the observation tube movable portion 10 without being dependent on a direction of the tilt operation of the observation tube movable portion 10. The conditions are: using the tension coil spring 80 having a small spring constant; assuring a long span; pulling the wire 79 in the tangent line direction T of the trajectory L of the wire fixing terminal 76 which moves to describe an arc in a state where the tilt angle α is set to the maximum angle; and setting the wire 79 to be pulled in the direction which deviates from the tangent line direction T of the trajectory T as the tilt angle α is changed from the maximum angle to the minimum angle.

Since the wire 79 and the tension coil spring 80 having the long span are hooked around the roller guide 77 and then bent, they can be reduced in size and provided in the lens barrel main body portion 10 having the narrow tilting observation tube.

The tension coil spring 80 can be replaced with another tension coil spring 80 having any other spring constant. As a result, even when each eye piece lens 15 (16) having a different mass is attached, the tilt operation can be performed with respect to the observation tube movable portion 10 with a uniform quantity of the operation force without being dependent on the direction of the tilt operation of the observation tube movable portion 10 in a full range of the tilt angle α.

A sixth embodiment according to the present invention will now be described. It is to be noted that like reference numerals denote parts equal to those in the fifth embodiment, thereby eliminating the detailed explanation.

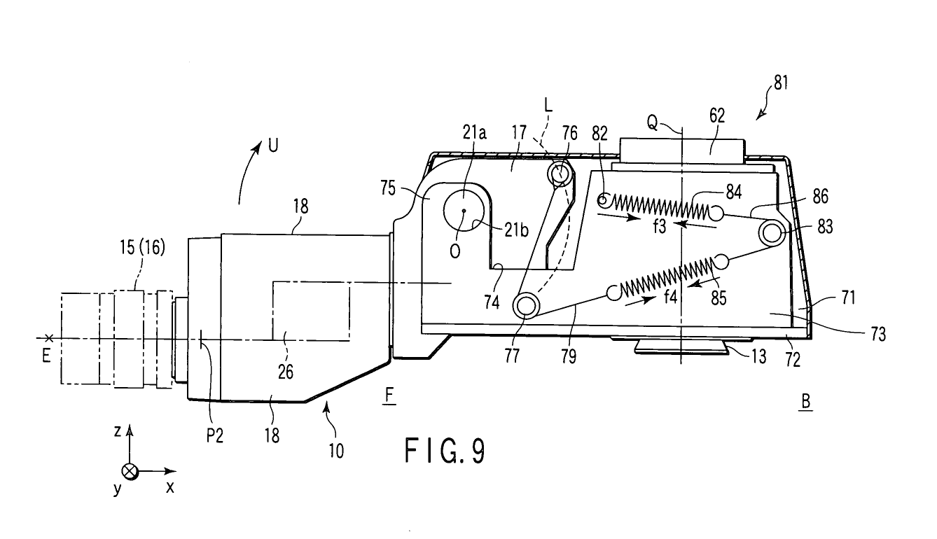

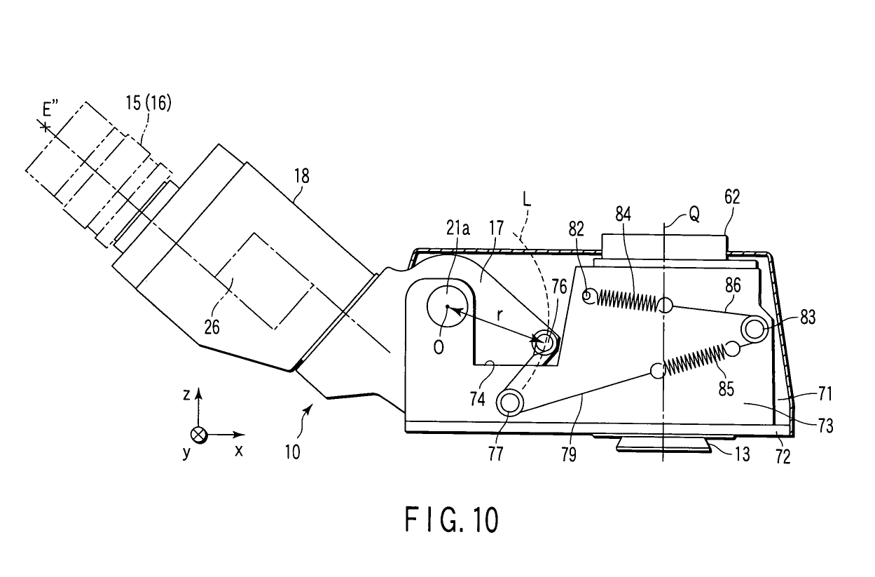

FIGS. 9 and 10 are block diagrams of a tilting observation tube for a microscope 81. FIG. 9 is a block diagram when a minimum tilt angle α is set. FIG. 10 is a block diagram when a maximum tilt angle α is set. The tilting observation tube for a microscope 81 has a less barrel main body 71. A spring hook member 82 is provided on a side plate 73 of the lens barrel main body 71. The spring hook member 82 is provided to be adjacent to an opening of a notch portion 74.

A roller guide 83 is provided at an upper part of the side plate 73 on a back surface B side.

One end of a first tension coil spring 84 is coupled with one end of a second tension coil spring 85 in series through a wire 86. The other end of the first tension coil spring 84 is caught by a spring hook member 82. The other end of the second tension coil spring 85 is fastened to a wire 79. The wire 86 is hooked around a roller guide 83. As a result, a straining member which couples the first tension coil spring 84, the second tension coil spring 85 and the respective wires 86 and 79 in series is stretched between a wire fixing terminal 76 and the spring hook member 82.

The first tension coil spring 84 has a force of contracting in a contraction direction f₃. The second tension coil spring 85 has a force of contracting in a contraction direction f₄. Therefore, the wire 79 and the first and second tension coil springs 84 and 85 give an impetus which swivels a observation tube movable portion 10 in a direction of an arrow U by the respective forces in the respective contraction directions f₃ and f₄.

The first and second tension coil springs 84 and 85 generate a torque in a direction which is opposite to tare weights of each eyepiece lens 15 (16) and the observation tube movable portion 10. As a result, the first and second tension coil springs 84 and 85 balance the tare weights of each eyepiece lens 15 (16) and the observation tube movable portion 10 and the torque in the direction opposite to the tare weights. It is to be noted that the first and second tension coil springs 84 and 85 each having a spring constant which is as small as possible are used.

Functions of the first and second tension coil springs 84 and 85 when adjusting an eye point will now be described.

A microscopic observer C1 (C2) swivels the observation tube movable portion 10. As a result, an eye point position varies in a range of a minimum tilt angle α shown in FIG. 9 and a maximum tilt angle α depicted in FIG. 10.

In a state where the tilt angle α is set to the minimum angle as shown in FIG. 9, a position of the wire fixing terminal 76 is the highest position on a trajectory L which moves around a swiveling axis O to describe an arc. In this state, a gap between the wire fixing terminal 76 and the spring hook member 82 is extended to the maximum level through each roller guide 77 and 83. Therefore, the first and second tension coil springs 84 and 85 are in a state where their both ends are expanded. As a result, the first and second tension coil springs 84 and 85 are in a state where an impetus is increased to the maximum level.

Consequently, the first and second tension coil springs 84 and 85 give a large impetus to the wire fixing terminal 76 through the respective wires 79 and 86. That is, the first and second tension coil springs 84 and 85 give the wire fixing terminal 76 a large impetus (=f₃+f₄) which swivels the observation tube movable portion 10 in a direction of an arrow U.

In a state where the tilt angle α is set to the maximum angle as shown in FIG. 10, a position of the wire fixing terminal 76 is the lowest position on the trajectory L which moves around the swiveling axis O to describe an arc. In this state, a gap between the wire fixing terminal 76 and the spring hook member 81 can be narrowed to the minimum level through each roller guide 77 and 82. Therefore, the first and second tension coil springs 84 and 85 are in a state where their both ends are contracted. As a result, the first and second tension coil springs 84 and 85 respectively have the minimum impetus.

As a result, the first and second tension coil springs 84 and 85 give a small impetus to the wire fixing terminal 76 through the respective wires 79 and 86. That is, the first and second tension coil springs 84 and 85 give the wire fixing terminal 76 the small impetus which swivels the observation tube movable portion 10 in a direction of an arrow U.

Next, in case of changing an eye point position, the microscopic observer C1 (C2) swivels the observation tube movable portion 10 in the direction of the arrow U or its opposite direction. At this time, the first and second tension coil springs 84 and 85 expand/contract to change the impetus which is given to the observation tube movable portion 10. That is, the first and second tension coil springs 84 and 85 reduce the impetus which is given to the observation tube movable portion 10 as the tilt angle α of the observation tube movable portion 10 is changed from the minimum angle to the maximum angle. The first and second tension coil springs 84 and 85 increase the impetus which is given to the observation tube movable portion 10 as the tilt angle α is changed from the maximum angle to the minimum angle.

In a state where the tilt angle α is set to the maximum angle, the respective wires 79 and 86 are set to be pulled in a tangent line direction T of the trajectory L of the wire fixing terminal 76 which moves to describe an arc. The respective wires 79 and 86 are set to be pulled in a direction which gradually deviates from the tangent line direction T of the trajectory L as the tilt angle α is changed from the maximum angle to the minimum angle. As a result, even when the tensile force of each of the first and second tension coil springs 84 and 85 is increased, a variation in a torque which swivels the observation tube movable portion 10 can be suppressed.

As described above, according to the sixth embodiment, the first and second tension coil springs 84 and 85 are used to reduce the impetus which is given to the observation tube movable portion 10 as the tilt angle α of the observation tube movable portion 10 is changed from the minimum angle to the maximum angle, and increase the impetus which is given to the observation tube movable portion 10 as the tilt angle α is changed from the maximum angle to the minimum angle.

As a result, the sixth embodiment can demonstrate the same effects as those of the fifth embodiment. Changing a spring constant of each of the first and second tension coil springs 84 and 85 can vary the impetus which is given to the observation tube movable portion 10 in accordance with a mass of the observation tube movable portion 10. Consequently, the optimum tilt operation can be performed. It is possible to use the first and second tension coil springs 84 and 85 each having a small size.

A seventh embodiment according to the present invention will now be described. Like reference numerals denote parts equal to those of the sixth embodiment, thereby eliminating their detailed explanation.

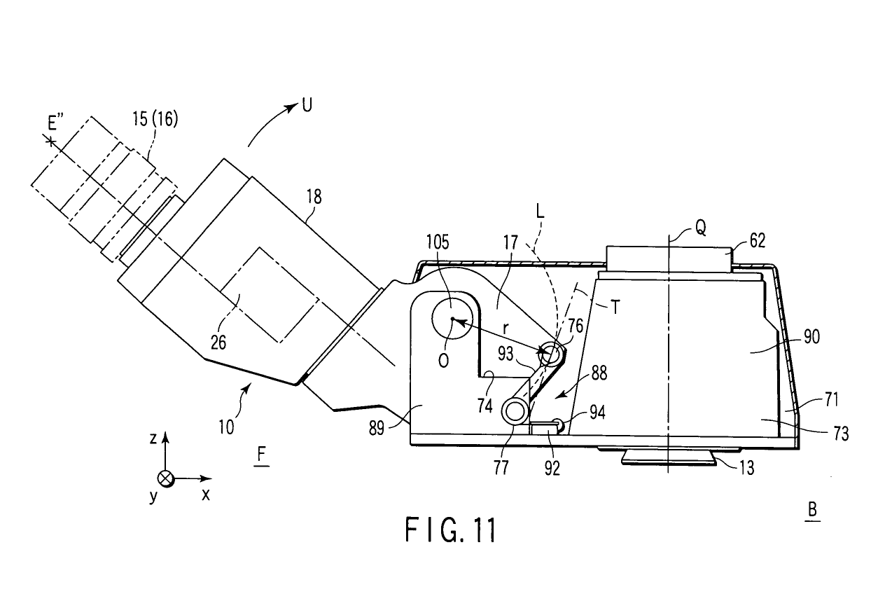

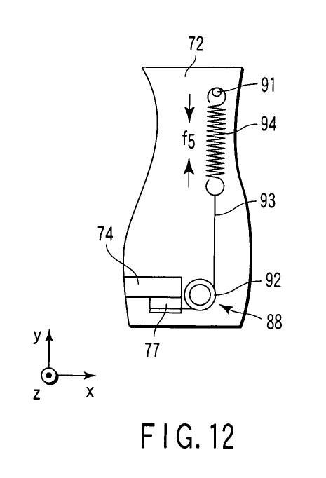

FIGS. 11 and 12 are block diagrams of a tilting observation tube for a microscope 87. FIG. 11 is a side elevation block diagram of the tilting observation tube for a microscope 87. FIG. 12 is a partially planimetric block diagram of the tilting observation tube for a microscope 87. A notch portion 88 is provided on a side plate 73. The notch portion 88 is provided at a lower part of the notch portion 74 of the side plate 73. The notch portion 88 divides the side plate 73 into a front side plate 89 and a rear side plate 90.

As shown in FIG. 12, a spring hook member 91 and a roller guide 92 are provided on a bottom plate 72. The spring hook member 91 and the roller guide 92 are provided with a predetermined gap therebetween in a direction vertical to a direction extending from a front surface F to a back surface B.

A wire 93 and a tension coil spring 94 which are coupled with each other in series are stretched between a wire fixing terminal 76 and the spring hook member 91. One end of the wire 93 is fixed to the wire fixing terminal 76. The wire 93 is hooked around each of roller guides 77 and 92. The other end of the wire 93 is coupled with one end of the tension coil spring 94 by, e.g., fastening.

The other end of the tension coil spring 94 is caught by the spring hook member 91. That is, the wire 93 and the tension coil spring 94 are bent by the respective roller guides 77 and 92 and stretched between the side plate 73 and the bottom plate 72.

The wire 93 and the tension coil spring 94 swivel the observation tube movable portion 10 in a direction of an arrow U by an impetus in a contraction direction f₅. The tension coil spring 94 generates a torque in a direction which is opposite to tare weights of each eyepiece lens 15 (16) and a observation tube movable portion 10. As a result, the tension coil spring 94 balances the tare weights of each eyepiece lens 15 (16) and the observation tube movable portion 10 and the torque in the direction opposite to the tare weights.

A function of the tension coil spring 94 when adjusting an eye point will now be described.

In a state where a tilt angle α is set to a minimum angle, a position of the wire fixing terminal 76 is the highest position on a trajectory L which moves around a swiveling axis O to describe an arc. In this state, a gap between the wire fixing terminal 76 and the spring hook member 91 is increased to the maximum level through the respective roller guides 77 and 92. Therefore, the tension coil spring 94 is in a stretched state. The tension coil spring 94 has an impetus increased to the maximum level. As a result, the tension coil spring 94 gives a large impetus to the wire fixing terminal 76 through the wire 93. That is, the tension coil spring 94 gives the wire fixing terminal 76 the large impetus which swivels the observation tube movable portion 10 in a direction of an arrow U.

In a state where the tilt angle α is set to a maximum angle, a position of the wire fixing terminal 76 is the lowest position on the trajectory L which moves around the swiveling axis O to describe an arc. In this state, the gap between the wire fixing terminal 76 and the spring hook member 91 is narrowed to the minimum level through the respective roller guides 77 and 92. Therefore, the tension coil spring 94 is in a contracted state. The tension coil spring 94 is in a state where an impetus of a tensile force is reduced to the minimum level. As a result, the tension coil spring 94 gives the small impetus to the wire fixing terminal 76 through the wire 93.

A microscopic observer C1 (C2) swivels the observation tube movable portion 10 in a direction of an arrow U or its opposite direction to change its eye point position. In this case, the tension coil spring 94 expands/contracts to change an impetus which is given to the observation tube movable portion 10. That is, the tension coil spring 94 reduces the impetus which is given to the observation tube movable portion 10 as the tilt angle α is changed from the minimum angle to the maximum angle. The tension coil spring 94 increases the impetus which is given to the observation tube movable portion 10 as the tilt angle α is changed from the maximum angle to the minimum angle.

In a state where the tilt angle α is set to the maximum angle, like the above-described example, the wire 93 is set to be pulled in a tangent line direction T of the trajectory L of the wire fixing terminal 76 which moves to describe an arc. The wire 93 is set to be pulled in a direction which gradually deviates from the tangent line direction T of the trajectory L as the tilt angle α is changed from the maximum angle to the minimum angle. As a result, even if a tensile force of the tension coil spring 94 is increased, a variation in a torque which swivels the observation tube movable portion 10 can be suppressed.

As described above, according to the seventh embodiment, the wire 93 and the tension coil spring 94 are bent by the respective roller guides 77 and 92 and stretched between the side plate 73 and the bottom plate 72 of the lens barrel main body 71. As a result, the same effects as those of the fifth embodiment can be demonstrated. The wire 93 and the tension coil spring 94 can be arranged by effectively utilizing a narrow space in the lens barrel main body 71. The wire 93 and the tension coil spring 94 may be arranged at any other positions on the bottom plate 72. It is possible to increase a degree of freedom of a space in which the wire 93 and the tension coil spring 94 are arranged.

An eighth embodiment according to the present invention will now be described. It is to be noted that like reference numerals denote parts equal to those in each of the foregoing embodiments, thereby eliminating their detailed explanation.

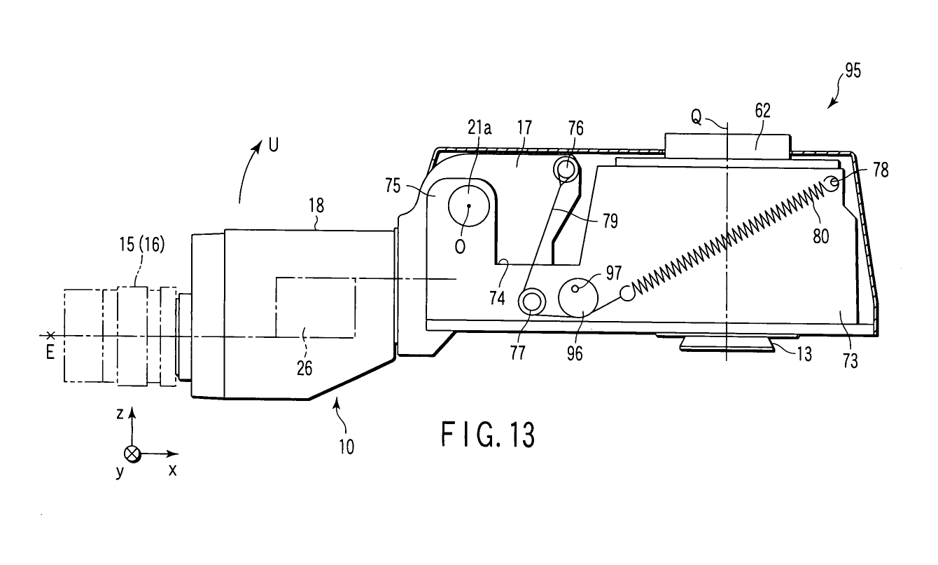

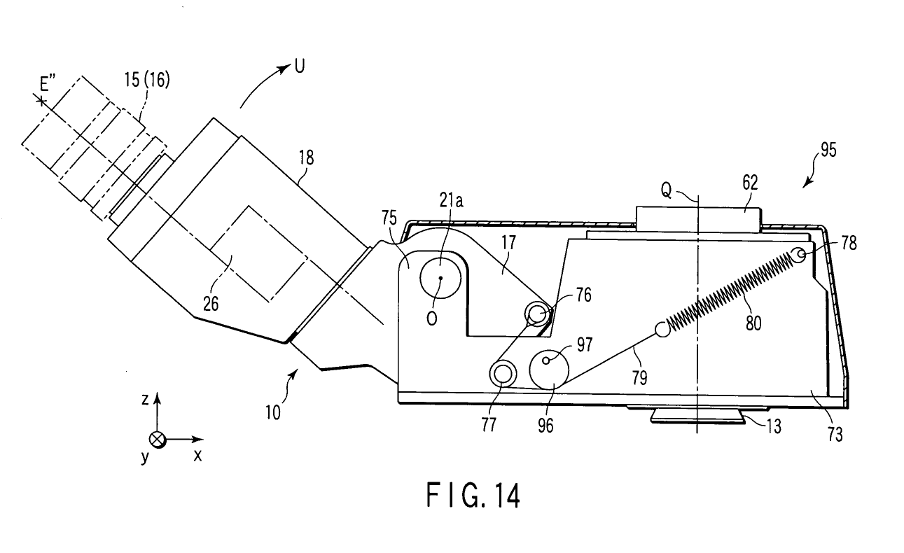

FIGS. 13 and 14 are block diagrams of a tilting observation tube for a microscope 95. FIG. 13 is a block diagram when a minimum tilt angle is provided. FIG. 14 is a block diagram when a maximum tilt angle is provided. An adjustment roller guide 96 is provided on a side plate 73. The adjustment roller guide 96 is provided in the vicinity of a line connecting a roller guide 77 with a spring hook member 78 on the side plate 73.

A pin 97 is provided to the adjustment roller guide 96. The pin 97 functions as a rotary axis Of the adjustment roller guide 96. The pin 97 is provided at a position which is eccentric from a center of the adjustment roller guide 96. The adjustment roller guide 96 rotates around the pin 97 to vary a tensile force with respect to a wire 79, thereby adjusting a tensile force which is applied to the wire 79 and a tension coil spring 80. After the adjustment roller guide 96 adjusts the tensile force which is applied to the wire 79 and the tensile coil spring 80, its rotation is fixed. Fixation of the adjustment roller guide 96 is effected by, e.g., clamping using a shoulder screw as the pin 97, fixing using an adhesive, or caulking.

A function when adjusting an eye point will now be described.

The adjustment roller guide 96 rotates center the pin 97. A tensile force is applied from the adjustment roller guide 96 to the wire 79 by eccentric rotation of the adjustment roller guide 96. A magnitude of the tensile force applied to the wire 79 varies in accordance with a rotation angle of the adjustment roller guide 96. When the tensile force is applied to the wire 79, a deformation quantity of the wire 79 varies. As a result, an expansion quantity of the tension coil spring 80 changes, thus varying the tensile force.

On the other hand, a direction of pulling a observation tube movable portion 10 by deformation of the wire 79 does not change. As a result, a torque applied to the observation tube movable portion 10 can be adjusted by simply changing the tensile force of the tension coil spring 80.

Therefore, a microscopic observer C1 (C2) rotates the adjustment roller guide 96. As a result, a quantity of a load when performing a tilt operation with respect to the observation tube movable portion 10 can be arbitrarily adjusted.

After adjusting a rotation angle of the adjustment roller guide 96, the adjustment roller guide 96 is fixed by, e.g., clamping using a shoulder screw as the pin 97, fixing using an adhesive or caulking.

Next, the microscopic observer C1 (C2) swivels the observation tube movable portion 10 in a direction of an arrow U or its opposite direction to change an eye point position. In this case, the tension coil spring 80 expands/contracts with the tensile force being applied thereto by the adjustment roller guide 96. That is, the tension coil spring 80 reduces an impetus which is given to the lens barrel movable portion 24 as the tilt angle α of the observation tube movable portion 10 is changed from the minimum angle to the maximum angle. The tension coil spring 80 increases an impetus which is given to the lens barrel movable portion 24 as the tilt angle α is changed from the maximum angle to the minimum angle.

As described above, according to the eighth embodiment, the adjustment roller guide 96 which adjusts the tensile force applied to the wire 79 and the tension coil spring 80 is provided. As a result, in addition to the effects of the fifth embodiment, a quantity of a load when performing the tilt operation with respect to the observation tube movable portion 10 can be arbitrarily adjusted.

The tensile force of the tension coil spring 80 can be adjusted. As a result, a torque which is given to the observation tube movable portion 10 can be changed. Even if each eyepiece lens 15 (16) having a different mass is attached, the microscopic observer C1 (C2) can obtain excellent operability.

It is to be noted that the present invention is not restricted to each of the foregoing embodiments, and these embodiments can be modified as follows.

For example, the microscope main body 3 is not restricted to an upright microscope, and it may be an inverted microscope or any other microscope.

Each of the reflection optical systems 28, 45 and 51 is not restricted to one which reflects a light beam which falls thereon from the image forming lens 11 for four times or two times, and it may reflects the light beam for an even number of times.

The prism 30 shown in FIG. 2 may be provided in such a manner that it can be inserted into/removed from the optical axis. The sixth reflecting mirror 41 shown in FIG. 4 may be provided in such a manner that it can be inserted into/removed from the optical axis. The sixth reflecting mirror 41 shown in FIG. 5 may be provided in such a manner that it can be inserted into/removed from the optical axis. Inserting the prism 30 or the sixth reflecting mirror 41 enables naked-eye observation using the eyepiece lens 15 (16). Retracting the prism 30 or the sixth reflecting mirror 41 from the optical axis enables imaging observation using an imaging device such as a photographic device or a television device. Therefore, naked-eye observation and imaging observation can be switched.

In the fifth to eight embodiments, each wire 79, 86 or 93 and each tension coil spring 80, 84, 85 or 94 may be provided on the respective side plates 73 on both sides. As a result, torques given to the observation tube movable portion 10 are evenly applied from right and left sides. The operability when performing the tilt operation with respect to the observation tube movable portion 10 can be improved.

In the fifth to eighth embodiments, the straining member is not restricted to each wire 79, 86 or 93 and each tension coil spring 80, 84, 85 or 94, and a member such as a belt may be used.

The tensile elastic member is not restricted to a spring member, and it is possible to use an elastic member such as a rubber member as well as any member which expands/contracts. As the tensile elastic member, the entire straining member may be formed of an elastic member such as a rubber member.

The hook member is not restricted to the roller guide 77, and it may be one which can slide a wire or a belt, e.g., a slide pin.

A position where the eccentric mechanism is provided is not restricted to the adjustment roller guide 96, and the eccentric mechanism may be provided to the roller guide 77, for example. As a result, a torque can be adjusted. In this case, a tensile force of the tension coil spring 80 is not changed. Changing a pulling direction can vary the torque which is applied to the observation tube movable portion 10.

The adjustment roller guide 96 may be used in each tilting observation tube for a microscope shown in FIGS. 9 to 12. As a result, each tilting observation tube for a microscope shown in FIGS. 9 to 12 can arbitrary adjust a quantity of a load when performing a tilt operation with respect to the observation tube movable portion 10.

The description has been given as to the case where the fifth to eighth embodiments are applied to the tilting observation tube for a microscope according to the fourth embodiment shown in FIG. 6. The present invention is not restricted thereto, and the fifth to eighth embodiments can be applied to the tilting observation tube for a microscope according to each of the first to third embodiments.

The optical system of the tilting observation tube for a microscope is not restricted to the configuration of the optical system described in conjunction with the foregoing embodiments, and a configuration of any other optical system may be of course adopted. The configuration of the tilting observation tube can be applied even when the center of swiveling of the observation tube movable portion 10 is provided at a position different from that of each of the foregoing embodiments. Besides the foregoing embodiments, a position of the lens barrel main body to which the straining member is attached may be arranged at an arbitrary position in accordance with a shape of the case main body or the lens barrel movable portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A tilting observation tube for a microscope, comprising:
a main body which is attached to a microscope main body;
a swiveling shaft which is provided to the main body;
a observation tube movable portion to which an eyepiece is attached and which is supported with respect to the main body in such a manner as to swivel on the swiveling shaft;
a first reflecting member which is provided in such a manner as to swivel on the swiveling shaft, and reflects a light beam from the microscope main body, the first reflecting member swiveling in conjunction with swiveling of the observation tube movable portion, an angle of the swiveling being ½ of a swiveling angle of the observation tube movable portion, a direction of the swiveling being the same as a rotating direction of the observation tube movable portion; and
a second reflecting member which reflects the light beam reflected by the first reflecting member toward the eyepiece.

2. The tilting observation tube for a microscope according to claim 1, wherein the swiveling shaft is provided on an upper surface side in the observation tube movable portion apart from the second reflecting member.

3. The tilting observation tube for a microscope according to claim 1, wherein the swiveling shaft is arranged at substantially the same height as an intermediate point of an arc-like trajectory formed when the eyepiece swivels.

4. The tilting observation tube for a microscope according to claim 1, wherein the first reflecting member has a reflecting surface which reflects the light beam, and is provided in such a manner that a reflection point of the light beam on the reflecting surface substantially matches with an axial direction of the swiveling shaft.

5. The tilting observation tube for a microscope according to claim 1, wherein the second reflecting member is fixed on a lower surface in the observation tube movable portion.

6. The tilting observation tube for a microscope according to claim 1, wherein the main body comprises:
an imagery lens which image-forms the light beam from the microscope main body, thereby forming an intermediate image in the main body; and
a relay lens which image-forms the intermediate image in the observation tube movable portion.

7. The tilting observation tube for a microscope according to claim 6, further comprising:
a reflection optical system which is provided between the image forming lens and the first reflecting member and leads the light beam from the microscope main body to the first reflecting member.

8. The tilting observation tube for a microscope according to claim 7, wherein the reflection optical system has at least two reflecting mirrors.

9. The tilting observation tube for a microscope according to claim 7, wherein the reflection optical system has a plurality of optical elements and is configured to change an incidence angle of the light beam to the first reflecting member by an arrangement of the respective optical elements.

10. The tilting observation tube for a microscope according to claim 7, further comprising:
an imaging device attachment portion which is provided on an optical axis from the microscope main body in the main body and to/from which an imaging device is configured to be attached/detached; and
a fixing member fixes one reflecting mirror,
wherein the reflection optical system has at least two reflecting mirrors, one reflecting mirror being provided on the optical axis from the microscope main body and reflecting the light beam, the other reflecting mirror reflecting the light beam reflected by one reflecting mirror toward the first reflecting member,
wherein the fixing member is configured to be inserted into/removed from an optical axis in the main body.

11. The tilting observation tube for a microscope according to claim 1, further comprising:
a straining member which strains the main body and the observation tube movable portion,
wherein a straining direction of the straining member substantially matches with a tangent line direction on a swiveling trajectory at an attachment position of the straining member in the observation tube movable portion at a swiveling angle with which a lens barrel angle of the observation tube movable portion with respect to the main body becomes maximum.

12. The tilting observation tube for a microscope according to claim 11, wherein the straining member gives an impetus in a direction along which a swiveling angle of the observation tube movable portion with respect to the main body is changed from a minimum angle to a maximum angle.

13. The tilting observation tube for a microscope according to claim 11, wherein a distance between one end and the other end of the straining member is increased and the straining member increases the impetus which is given to the observation tube movable portion as the swiveling angle of the observation tube movable portion is reduced to the minimum angle, and
the gap between one end and the other end of the straining member is reduced and the straining member reduces the impetus which is given to the observation tube movable portion as the swiveling angle of the observation tube movable portion is increased to the maximum angle.

14. The tilting observation tube for a microscope according to claim 11, wherein the straining member has at least one tensile elastic member.

15. The tilting observation tube for a microscope according to claim 14, wherein the straining member has at least one streak thing which is coupled with the tensile elastic member.

16. The tilting observation tube for a microscope according to claim 11, further comprising:
at least one hook member which is provided to the main body and comes into contact with the straining member to bend a tensile force direction of the straining member.

17. The tilting observation tube for a microscope according to claim 11, further comprising:
a tensile force adjustment member which is configured to give a tensile force to the straining member and adjust the tensile force,
wherein the tensile force adjustment member is configured to give a tensile force to the straining member and adjust the tensile force.

18. The tilting observation tube for a microscope according to claim 11, further comprising:
at least one hook member provided to the main body;
a first fixing portion which is attached to the observation tube movable portion; and
a second fixing portion attached to the main body,
wherein the straining member is stretched between the first fixing portion and the second fixing portion through the hook member, and gives an impetus in a direction of swiveling the observation tube movable portion with respect to the main body from a minimum rotating angle to a maximum rotating angle, and
a straining direction of the straining member which is stretched between the first fixing portion and the hook member substantially matches with a tangent line direction on a trajectory of the first fixing member which moves with swiveling of the observation tube movable portion in a state where the swiveling angle of the observation tube movable portion with respect to the main body is maximum.

19. A tilting observation tube for a microscope, comprising:
a main body which is attached to a microscope main body;
a observation tube movable portion to which an eyepiece is attached and which is supported with respect to the main body in such a manner as to swivel; and
a straining member which strains the main body and the observation tube movable portion,
wherein a straining direction of the straining member substantially matches with a tangent line direction on a swiveling trajectory of the observation tube movable portion at an attachment position of the straining member at a swiveling angle with which a lens barrel angle of the observation tube movable portion with respect to the main body becomes maximum.

20. The tilting observation tube for a microscope according to claim 19, wherein the straining member gives an impetus in a direction of swiveling the observation tube movable portion with respect to the main body from a minimum swiveling angle to a maximum swiveling angle.

21. The tilting observation tube for a microscope according to claim 19, wherein a gap between one end and the other end of the straining member is increased and the straining member increases an impetus which is given to the observation tube movable portion as a swiveling angle of the observation tube movable portion is reduced to the minimum level, and
the gap between one end and the other end of the straining member is reduced and the straining member decreases the impetus which is given to the observation tube movable portion as the swiveling angle of the observation tube movable portion is increased to the maximum level.

22. The tilting observation tube for a microscope according to claim 19, wherein the straining member has at least one tensile elastic member.

23. The tilting observation tube for a microscope according to claim 22, wherein the straining member has at least one streak thing which is coupled with the tensile elastic member.

24. The tilting observation tube for a microscope according to claim 19, further comprising:
at least one hook member which is provided to the main body and comes into contact with the straining member to bend a tensile force direction of the straining member.

25. The tilting observation tube for a microscope according to claim 19, further comprising:
a tensile force adjustment member which is configured to give a tensile force to the straining member and adjust the tensile force,
wherein the tensile force adjustment member is configured to give a tensile force to the straining member and adjust the tensile force.

26. The tilting observation tube for a microscope according to claim 19, further comprising:
at least one hook member which is provided to the main body;
a first fixing portion which is attached to the observation tube movable portion; and
a second fixing portion which is attached to the main body,
wherein the straining member is stretched between the first fixing portion and the second fixing portion through the hook member, and gives an impetus in a direction of swiveling the observation tube movable portion with respect to the main body from a minimum swiveling angle to a maximum swiveling angle, and
a straining direction of the straining member which is stretched between the first fixing portion and the hook member substantially matches with a tangent line direction on a trajectory of the first fixing member which moves with swiveling of the observation tube movable portion in a state where the swiveling angle of the observation tube movable portion with respect to the main body is maximum.
